(19) United States
(12) Patent Application Publication
(10) Pub. No.: US 2026/0145398 A1
(43) Pub. Date: May 28, 2026

(54) METHOD FOR MANUFACTURING A MOLDED FUNCTIONAL PART

(71) Applicant: Sumitomo Riko Company Limited, Aichi-ken (JP)

(72) Inventors: Jozsef KONDOR, Künzell (DE); Anna-Lena WAHL, Freiensteinau (DE)

(21) Appl. No.: 19/400,091

(22) Filed: Nov. 25, 2025

(30) Foreign Application Priority Data
Nov. 27, 2024 (DE) 10 2024 135 063.6

(51) Int. Cl. B29C 70/84; B29C 70/68; B29K 705/00; B29L 31/04; B29L 31/30; F16C 27/06

(52) U.S. Cl. CPC B29C 70/84; B29C 70/682; F16C 27/063; B29K 2705/00; B29L 2031/04; B29L 2031/3002; F16C 2326/01

(57) ABSTRACT

A method for manufacturing a molded functional part and to a molded functional part is provided. Further, a molded part is also provided. According to the method, a molding tool which is capable of introducing a rubber or plastic material is provided., At least one metal part, to be molded into the rubber or plastic material is inserted into the chamber. Anuxiliary placing portions is placed in the chamber, such that the metal parts to be molded are held stationary and at a distance from walls of the chamber while the rubber or plastic material is inputted. The rubber or plastic material is introduced into the molding tool. The auxiliary placing portions are shaped on their side facing the metal part(s) to be molded. A chassis bearing made by the method is also provided.

### FIELD

The present disclosure relates to a method for manufacturing a molded functional part, and a molded part.

### BACKGROUND

Methods in which corresponding operations are performed are known in the prior art. The auxiliary placing portions according to the prior art are usually small blocks made of metal which rest on an edge portion of the tool in a process for vulcanizing or injecting rubber or plastic. In the region of these auxiliary placing portions, the end-facing surfaces of the auxiliary placing portions which point away from the metal parts to be molded are not encased in rubber

or plastic and are exposed to the environment when a molded functional part, in particular a bearing, is in operation. This can lead to corrosive incidences which can then also spread to the metal parts of the molded functional part. This can impact the service life of a molded functional part and can even lead to stresses during operation, such as noise pollution, mechanical stresses, etc., if for example road salt on the roads leads to increased corrosion.

Since molded functional parts such as are to be manufactured in accordance with the invention are mass-produced items which are subject to high cost pressures, extensive finishing treatments are hardly feasible for such molded functional parts.

One prior-art attempt to counteract the problems of corrosion and ageing in corresponding parts is to latterly coat the auxiliary placing portions with corrosion-inhibiting materials such as a zinc-nickel alloy, which provide temporary protection against corrosion. This measure alone massively increases the cost of correspondingly manufactured parts and is consequently only feasible if the buyer of such parts is willing to bear the additional cost.

### SUMMARY

According to an embodiment, there is provided a method for manufacturing a molded functional part, in particular a vehicle bearing is provided. The method comprises providing a molding tool which is capable of introducing a rubber or plastic material, which can be hot-molded, into a chamber which can be reversibly sealed and which forms part of the molding tool. The method further comprises inserting into the chamber at least one one metal part of the molded functional part which are to be molded into the rubber or plastic material. The method further comprises providing auxiliary placing portions, such that the metal parts to be molded are held stationary and at a distance from walls of the chamber while the rubber or plastic material is inputted. The method further comprises introducing the rubber or plastic material into the molding tool. The auxiliary placing portions are formed as contact minimization geometries on the at least one metal part to be molded, and wherein they are shaped in such a way that a minimized contact, in particular a linear or punctiform contact is achieved between the contact minimization geometries of the metal part and corresponding connecting geometries.

According to an embodiment, there is provided a chassis bearing comprising a receiving sleeve capable of receiving a vehicle portion. The chassis bearing further comprising an intermediate layer; an intermediate sleeve an additional intermediate layer, and a cylindrical outer sleeve. The intermediate layers comprise a rubber or plastic material. The intermediate layers also comprise a number of auxiliary placing portions which comprise at least one of the receiving sleeve, the intermediate sleeve and the outer sleeve. The auxiliary placing portions correspond to a number of contact minimization geometries arranged on at least one end-facing side of at least one of the sleeves, wherein the contact minimization geometries are formed in a contact-minimizing way.

Accordingly, in accordance with the disclosed embodiments, a method for manufacturing a molded functional part, in particular a bearing or bushing may be provided, which provides a product which exhibits little corrosion under normal environmental conditions while simultaneously minimizing the manufacturing steps. A corresponding bearing is also provided in accordance with the embodiments.

Surprisingly, a corresponding manufacturing method only needs to be modified to the extent that the auxiliary placing portions are shaped on their side facing the metal part(s) to be molded, for example an end-facing side, in such a way that a minimized contact region, in particular a linear and/or punctiform contact, is achieved between the auxiliary placing portions and the metal part(s) to be molded. If corrosion occurs, it is only minimally transferred to the adjoining metal parts, since the auxiliary placing portion has a minimized area of contact with the metal parts to be molded which are to be held during manufacture, such that their surfaces on the end-facing side can be almost completely coated with rubber or plastic.

The auxiliary placing portions can be components of the tool and can be separately provided parts which each co-operate with corresponding geometries on the metal parts to be inserted and injected in order to achieve the desired punctiform and/or linear contacts.

Particularly preferably, the auxiliary placing portions are incorporated into molding tool parts of the molding tool, for example by spark erosion or milling. The auxiliary placing portions can also be inserted, for example press-fitted, into the molding tool parts as additional components, such as pins.

A punctiform contact is most favorable. A linear contact can however also keep the potential corrosion nuclei away from the vulcanized or injected metal parts, also called inserts, for a very long time and minimize corrosion of these metal parts over a long period of time. This can multiply the service life of a molded functional part manufactured in accordance with the invention, in particular a bearing, wherein the manufacturing cost and therefore the final product cost remain unaffected or can even be reduced.

The metal parts to be molded are then also provided with contact minimization geometries in holding regions between the auxiliary placing portions and the metal parts. This measure can also assist in achieving the effects and advantages cited above.

The auxiliary placing portions can also be formed in a surface-minimizing way on their side facing away from the metal parts or inserts. This can mean that the auxiliary placing portions are also partially vulcanized or injected, which can advantageously reduce the surface of the auxiliary placing portions facing outwards.

In accordance with the invention, a molded functional part such as a chassis bearing, such as for example a torsion bar bearing, or a bearing bushing is also provided in accordance with the present invention, comprising a hollow-cylindrical tubular portion capable of receiving a functional element on a vehicle, such as for example a torsion bar, wherein an intermediate tubular portion and a casing tubular portion are provided which are connected to each other via a preferably permanently elastic rubber or plastic material which holds the hollow-cylindrical tubular portion, preferably in a damping way, on the intermediate tubular portion and also holds it, preferably in a damping way, on the casing tubular portion. It will be appreciated that, in an embodiment, the rubber or plastic material may preferably comprise a damping material. For manufacturing purposes, a number of auxiliary placing portions are provided which are arranged on at least one end-facing side of at least one of the tubular portions in order to keep the different portions away from the walls of the tool which is used for manufacturing the torsion bar bearing in accordance with the invention. In accordance with the invention, the auxiliary placing portions are formed in a contact-minimizing way on their side facing the end-facing side of one of the tubular portions, such that a punctiform and/or linear contact between the hollow-cylindrical tubular portions and the auxiliary placing portions is for example achieved.

In order to enable secure placement during manufacture, at least three contact minimization geometries should be provided, preferably uniformly over the outer circumference on the end-facing side of the tubular or sleeve portions to be molded, which during manufacture can be assigned to corresponding auxiliary placing portions which are separate or incorporated into the molding tool.

Advantageously, the portions which are to be used and which are usually made of metal can also be formed at the points of contact with the auxiliary placing portions in such a way that they are provided with contact minimization geometries.

The auxiliary placing portions, if they are formed separately and are to be inserted into the molding tool together with the tubular portions or have been press-fitted into the molding tool beforehand, can also be formed with a surface-minimizing geometry on their side facing away from the portions which are usually made of metal, such that they can also be at least partially vulcanized with rubber or such that plastic can be at least partially injected around them during manufacture.

Manufacturing and/or forming a product in accordance with the invention cannot completely prevent rust from forming, but it is possible to reduce the amount of rust or metal oxides formed to such an extent that subsequent migration of the rust formed into the manufactured molded functional part or vehicle bearing, such as a torsion bar bearing, can be minimized. This means that the bond between the metal and the rubber or plastic in the manufactured molded functional part can be maintained over a long period of time without this requiring additional steps in the manufacturing method, and that the manufacturing cost and the cost of the finished product can therefore remain constant or even be reduced.

The manufacturing method and a manufactured molded functional part, in particular a chassis bearing or bearing bushing, in accordance with the invention are explained in more detail below on the basis of the attached figures, wherein identical reference signs denote identical components, such that it is unnecessary to repeatedly describe these components.

### DRAWING DESCRIPTIONS

FIG. 1a shows a perspective plan view of a configuration of tubular portions of an embodiment which has been prepared for vulcanizing a rubber material or injecting a plastic material.

FIG. 1b shows a section along the cylinder axis of the embodiment in accordance with FIG. 1a.

FIG. 1c shows a perspective plan view of the position and contact of an auxiliary placing portion on a contact minimization geometry of a metal part or insert of a molded functional part, wherein a punctiform contact is shown in this case.

FIG. 1d shows a sectional representation of the position of a contact minimization geometry in accordance with the section according to FIG. 1b, on an end-facing side of a metal part to be molded.

FIG. 1e shows a shape of the contact minimization geometry of the first embodiment, in a lateral view.

FIG. 1f shows a perspective plan view onto another embodiment of a contact minimization geometry on an upper edge or end-facing side of a metal part to be molded.

FIG. 2a shows a perspective plan view onto another embodiment of a molded functional part in accordance with the invention, wherein in this case a linear contact between a contact minimization geometry and an auxiliary placing portion on a molding tool is provided.

FIG. 2b shows a perspective plan view onto an end-facing surface of a molded functional part in accordance with the invention and in this case documents a linear contact.

FIG. 2c shows a side view showing a punctiform contact.

FIG. 2d shows a perspective plan view onto another embodiment of a contact minimization geometry with respect to an auxiliary placing portion in accordance with the invention.

FIGS. 3a to 3e schematically show a method in accordance with the invention for manufacturing a molded functional part, wherein:

FIG. 3a schematically shows a section through an injection molding tool for manufacturing a molded functional part in accordance with the invention, along the cylinder axis of the tool and the molded part;

FIG. 3b shows the section in accordance with FIG. 3a, with the tool open;

FIG. 3 c shows a sectional detail Y in accordance with FIG. 3 b, assigned to a contact minimization geometry;

FIG. 3 d shows a sectional detail X of the molding tool in accordance with FIG. 3 b, corresponding to FIG. 3c, wherein said detail illustrates an auxiliary placing portion on the molding tool;

FIG. 3e shows an exploded representation in a perspective side view of the molding tool and the molded part.

### DETAILED DESCRIPTION

The figures are adduced below to describe preferred embodiments in accordance with the invention, wherein identical reference signs in the different figures denote identical components. To this extent, it is not necessary to repeatedly discuss identical components for all the figures.

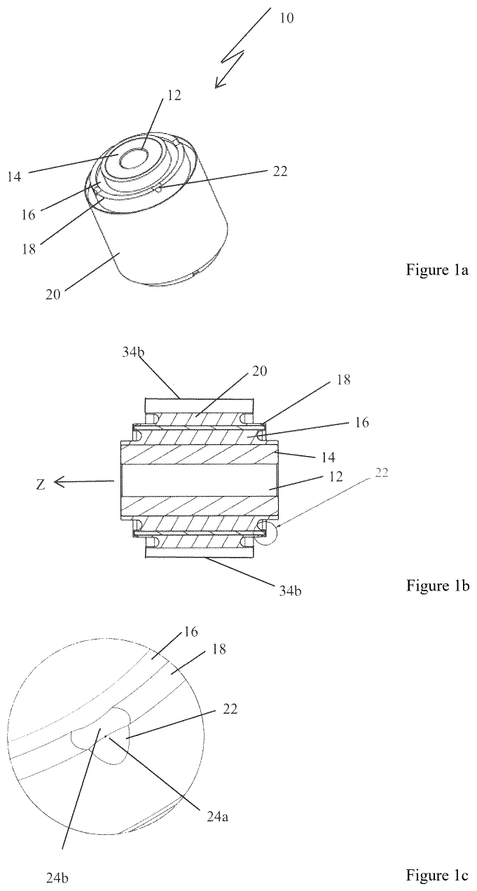

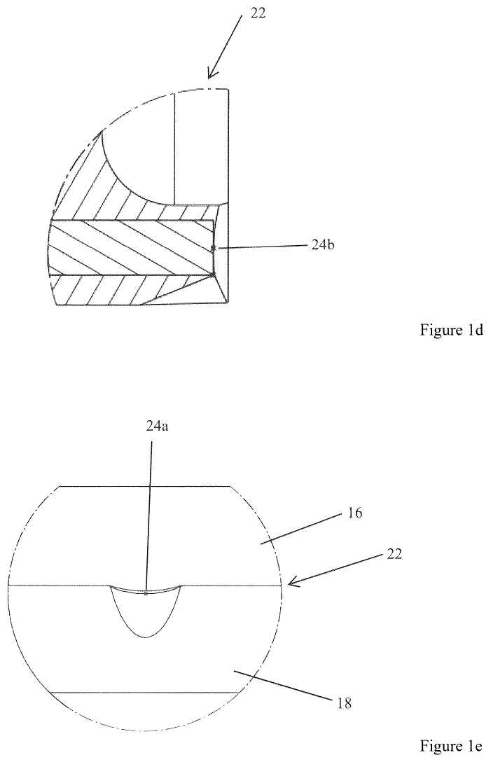

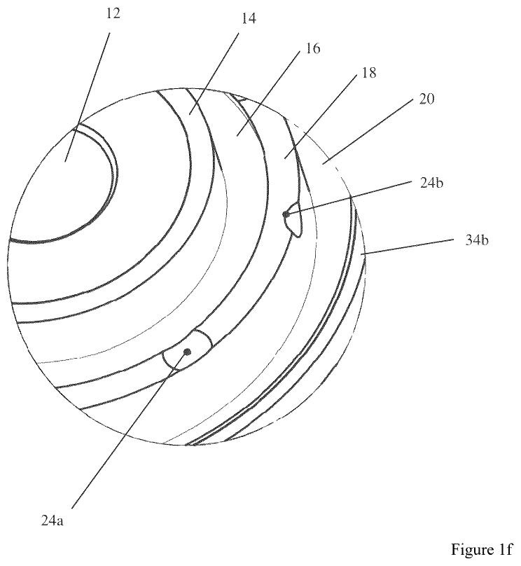

FIG. 1a shows a molded functional part or chassis bearing 10. The chassis bearing 10 contains a cylindrical hollow space 12 in the middle which forms a receiving opening 12.

The chassis bearing 10 in accordance with the invention can be designed to be cylindrically symmetrical overall, but can also exhibit a different shape as long as a corresponding chassis portion can be held.

The chassis bearing 10 also comprises a receiving sleeve 14 which is held via a cylindrical intermediate layer 16, preferably made of a rubber or plastic material, on an intermediate sleeve 18 which is in turn surrounded by an additional intermediate layer 20. The preferably cylindrical additional intermediate layer 20 is preferably also made of a rubber material or plastic material. An outer sleeve 34b which is indicated in FIG. 1b but not in

FIG. 1a can extend around the additional intermediate layer 20. The intermediate layer 16 and the additional intermediate layer 20 are injection-molded from one or more thermoplastic materials, such as rubber or plastic as indicated above, which should be permanently elastic.

A contact minimization geometry 22, the position of which with respect to the end-facing side of the intermediate sleeve 18 can in particular be seen more clearly from FIG. 1b, is provided in the end-facing side of the intermediate sleeve 18. The position of the outer sleeve 34b around the additional intermediate layer 20 is shown. The contact minimization geometry 22 is highlighted again in FIGS. 1c to 1e. In accordance with FIG. 1c, the contact minimization geometry 22 forms two punctiform contacts 24a, 24b in the present case, wherein the position of the punctiform contacts can be seen in FIG. 1d with respect to the punctiform contact 24b located on the end-facing side and in FIG. 1e with respect to the punctiform contact 24a provided slightly to the side. FIG. 1f shows a variant in accordance with another embodiment in which the punctiform contacts are offset with respect to each other. The punctiform contact 24a supports the components in the direction of the cylinder axis Z (see for example FIG. 1c) during production, while the punctiform contact 24b supports them radially outwards.

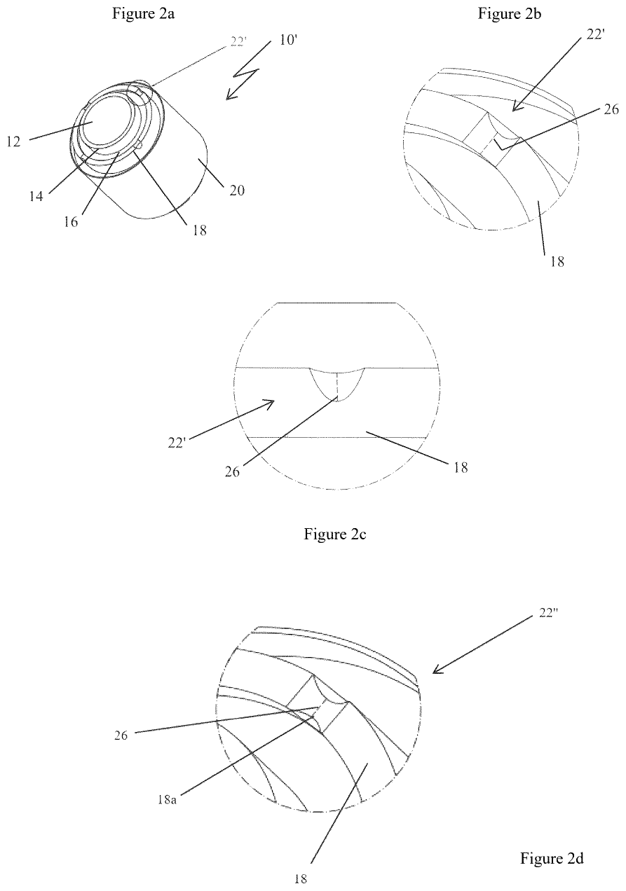

FIGS. 2a to 2c show another embodiment in accordance with the invention, in which a contact minimization geometry 22′ is shown which is capable of forming a linear contact 26 which is provided on the end-facing side of the intermediate sleeve 18, wherein corresponding auxiliary placing portions are to be provided on connecting geometries (not shown here) of a suitable molding tool (not shown here).

A punctiform contact 24b is achieved laterally between the molding tool and the contact minimization geometry 22′.

In this case, an outer sleeve 34b can again be provided around the additional intermediate layer 20 shown, as can be seen from FIG. 1b.

Another embodiment is disclosed in FIG. 2d, wherein a contact minimization geometry 22″ is in this case provided on a geometry 18a which is constricted with respect to the end-facing side of the intermediate sleeve 18, such that that a linear contact 26 which is shortened as compared to FIG. 2b is achieved.

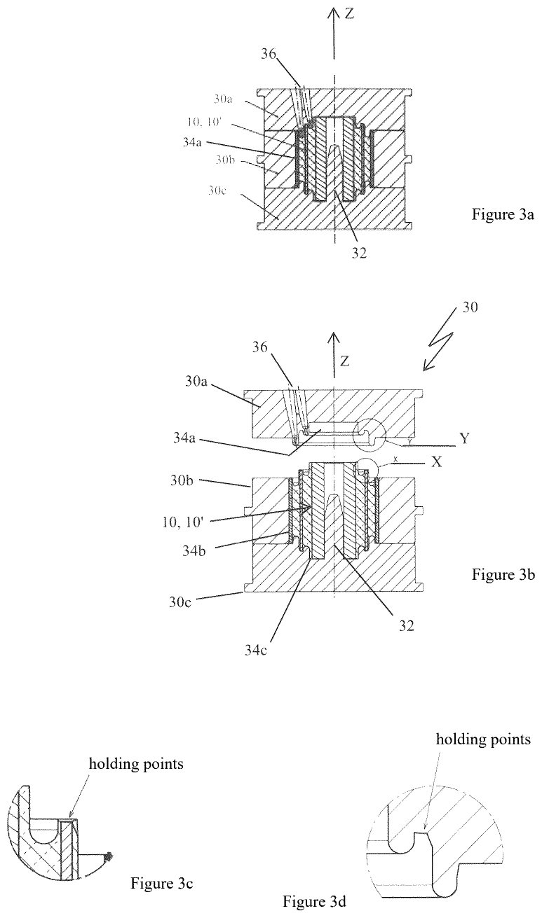

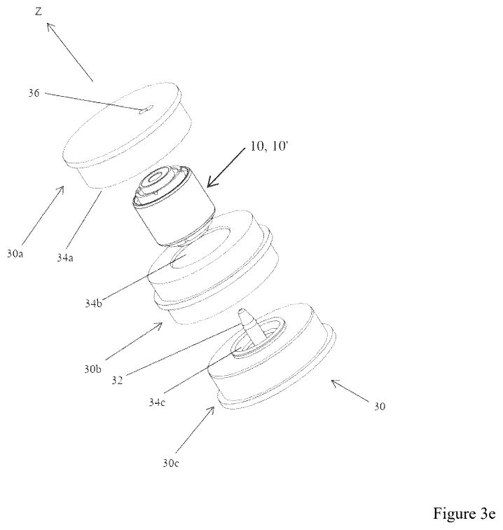

FIGS. 3a to 3e show a molding tool 30 in conjunction with a chassis bearing 10, 10′ as a preferred molded functional part in accordance with the invention.

FIG. 3a shows three segments 30a, 30b, 30c which form molding tool parts 30a, 30b, 30c of the molding tool 30. The upper molding tool part 30a contains two material feeds 36 via which thermoplastic material, in particular rubber and/or plastic such as for example TP, TPE, polyurethane, or the like, can be inputted. A mandrel 32 which is provided centrically with respect to the cylinder axis Z holds the chassis bearing 10 and in particular the receiving sleeve 14.

The three molding tool parts 30a, 30b, 30c together form a chamber which receives the metal parts 14, 18 of the chassis bearing 10, 10′ in the first stage of manufacturing the chassis bearing.

If the molding tool parts 30a, 30b, 30c are moved together and connected to each other, reversibly but in a pressure-tight way, the thermoplastic material is introduced via the material feed 36 in order to connect the metal parts of the chassis bearing and to isolate them as far as possible from the environment of the chassis bearing 10, 10′ in order to delay as far as possible and ideally prevent oxidation of the metal parts.

In order to temporarily fix the metal parts in their positions in the molding tool 30 for the manufacturing step of inputting the thermoplastic material, the molding tool parts 30a and 30c of the molding tool 30 comprise upper and lower connecting geometries 34a, 34c, against the end-facing sides of which the metal parts 14, 18 rest during production via contact minimization geometries 22, 22′, 22″ which are separate or provided on the connecting geometries 34a, 34c, and which provide the punctiform contacts and/or linear contacts, wherein holding points are for example marked in FIGS. 3c and 3d.

The outer sleeve 34b, which usually surrounds the additional intermediate layer 20 of the chassis bearing 10, 10′ in accordance with the invention, can be seen in this case. The outer sleeve 34b is usually made of metal.

The regions X and Y, which are shown in isolation in FIGS. 3c and 3d as partial drawings with the tool 30 open, are highlighted separately in FIG. 3b. FIGS. 1a to 2d discussed above disclose the corresponding contours 22, 22′, 22″ of the contact minimization geometry which provide punctiform and/or linear contacts. FIGS. 3c and 3d merely show the holding points which are in contact during the production process.

FIG. 3e shows the perspective embodiment of the different molding tool parts 30a, 30b, 30c in relation to the chassis bearing 10, 10′ again, in an exploded representation.

Instead of a cylindrical molding tool 30, it would of course also be possible to use other shapes matching the outer shape of the chassis bearing 10, 10′.

In order to manufacture molded functional parts, such as the chassis bearing 10, 10′, which are to be isolated from the environment as far as possible but cost-effectively, the present invention can of course also be applied to such objects and is not limited to chassis bearings of the shape described in this case.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### LIST OF REFERENCE SIGNS

10, 10′molded functional part, chassis bearing
12 receiving opening
14 receiving sleeve, metal parts
16 (cylindrical) intermediate layer
18 intermediate sleeve, metal parts
18a constricted geometry
20 additional intermediate layer
22, 22′, 22″ contact minimization geometry
24a, 24b punctiform contacts
26 linear contact
30 molding tool
30a, 30b, 30c molding tool parts
32 mandrel
34a upper connecting geometry
34b outer sleeve
34c lower connecting geometry
36 material feed
Z cylinder axis

1. A method for manufacturing a molded functional part comprising the following steps:
providing a molding tool which is capable of introducing a hot-moldable rubber or plastic material into a chamber configured to be reversibly sealed and which forms part of the molding tool;
inserting into the chamber at least one metal part of the molded functional part which is to be molded into the rubber or plastic material;
providing auxiliary placing portions, such that the metal parts to be molded are held stationary and at a distance from walls of the chamber while the rubber or plastic material is inputted; and
introducing the rubber or plastic material into the molding tool,
wherein the auxiliary placing portions are formed as contact minimization geometries on the at least one metal part to be molded, wherein the auxiliary placing portions are shaped in such a way that a minimized contact, is achieved between the contact minimization geometries of the metal part and corresponding connecting geometries.

2. The method according to claim 1, wherein the minimized contact is a linear contact.

3. The method according to claim 1, wherein the minimized contact is achieved via at least one punctiform contact.

4. The method according to claim 2 wherein, the contact minimization geometries are provided on an assigned connecting geometry of the molding tool.

5. The method according to claim 3 wherein, the contact minimization geometries are provided on an assigned connecting geometry of the molding tool.

6. The method according to claim 1 wherein the at least one metal part comprises a plurality of metal parts.

7. The method according to claim 1 wherein the at least one metal part comprises at least one end facing side, and wherein a connecting contour is provided on at least one end-facing side of at least one of the metal parts to be molded, wherein the connecting contour aids in forming the minimized contact.

8. The method according to claim 6 wherein the at least one metal part comprises at least one end facing side, and wherein a connecting contour is provided on at least one end-facing side of at least one of the metal parts to be molded, wherein the connecting contour aids in forming the minimized contact.

9. A chassis bearing comprising:
a receiving sleeve capable of receiving a vehicle portion;
an intermediate layer;
an intermediate sleeve;
an additional intermediate layer; and
a cylindrical outer sleeve,
wherein the intermediate layers comprise
a rubber or plastic material; and
a number of auxiliary placing portions which comprise at least one of the receiving sleeve, the intermediate sleeve or the outer sleeve,
wherein the auxiliary placing portions correspond to a number of contact minimization geometries arranged on at least one end-facing side of at least one of the sleeves, and
wherein the contact minimization geometriesare formed in a contact-minimizing way.

10. The chassis bearing according to claim 9, wherein the contact minimization geometries are formed as a structure which achieves at least one punctiform contact.

11. The chassis bearing according to claim 10, wherein the contact minimization geometries are formed in such a way that a linear contact is achieved.

12. The chassis bearing according to claim 9, wherein at least one of the additional intermediate layer or the intermediate layer comprises a rubber or plastic material.

13. The chassis bearing according to claim 12 wherein the rubber or plastic material preferably comprises TP, TPE or a polyurethane.

14. The chassis bearing according to claim 12 wherein the rubber or plastic material is permanently elastic.

15. The chassis bearing according to claim 12 wherein the rubber or plastic material comprises a damping material.

16. The chassis bearing according to claim 12 wherein the rubber or plastic material can be thermoplastically molded.
